(19) United States
(12) Patent Application Publication
(10) Pub. No.: US 2025/0077360 A1
(43) Pub. Date: Mar. 6, 2025

(54) DATA RECOVERY METHOD AND DATA RECOVERY SYSTEM

(71) Applicant: Hitachi, Ltd., Tokyo (JP)

(72) Inventors: Mitsuo HAYASAKA, Tokyo (JP); Yuto KAMO, Tokyo (JP); Akira YAMAMOTO, Tokyo (JP)

(73) Assignee: Hitachi, Ltd., Tokyo (JP)

(21) Appl. No.: 18/601,179

(22) Filed: Mar. 11, 2024

(30) Foreign Application Priority Data
Aug. 29, 2023 (JP) 2023-139288

(51) Int. Cl. G06F 11/14; G06F 21/56

(52) U.S. Cl. CPC G06F 11/1469; G06F 21/566; G06F 2201/84; G06F 2221/034

(57) ABSTRACT

When the latest data and a backup of the latest data are infected, the data is recovered from the backup older than the data. Therefore, it is necessary to eliminate a difference from the latest data, leading to loss of business opportunities. A data recovery system that recovers data stored in a storage system includes a storage device that holds original data, an analyzing server that holds a copy of the original data, and generates formatted data by formatting the copy data for analysis, a managing server that holds the copy data and data history management information storing a history of the formatted data, and a data recovery unit that refers to the data history management information, selects the copy data or the formatted data as recovery data, and recovers the data from the selected recovery data when a security threat is detected in the data.

### BACKGROUND

The present invention relates to a data recovery method and a data recovery system.

In recent years, service-destroying attacks, represented by ransomware, have been rapidly increasing. These attacks not only force services of IT systems in operation to stop, but also destroy data and backup data of the IT systems, resulting in severe damage to the IT systems and businesses.

Therefore, it is necessary to avoid loss of business opportunities by restoring the IT systems using the latest data as possible.

US2021/0216628 discloses that when it is determined that a system or the like is likely to have been exposed to a security threat, a parameter relating to protection, such as retention or backup, is changed and a loss of a recovery data set is prevented and the frequency at which a recovery data set is generated is increased.

### SUMMARY

In the invention described in US2021/0216628, when the latest data and a backup of this data become infected, the data is recovered from data older than the latest data. Thus, the data is restored using the very old data. Therefore, it is necessary to eliminate a difference from the latest data, leading to loss of business opportunities.

That is, it is not considered to recover the data from a new copy of data used for data utilization as possible.

To solve the above-described problems, a data recovery system that recovers data stored in a storage system includes a storage device that holds original data, an analyzing server that holds copy data that is a copy of the original data, and generates formatted data obtained by formatting the copy data for analysis, a managing server that holds the copy data and data history management information storing a history of the formatted data, and a data recovery unit that refers to the data history management information, selects the copy data or the formatted data as recovery data, and recovers the data from the selected recovery data when a security threat is detected in the data.

Even when data in an IT system is exposed to a security threat such as ransomware infection, a possibility that the data can be recovered using the latest data used for formatting or analysis increases.

### BRIEF DESCRIPTION OF THE DRAWINGS

FIG. 1 is an example of a block diagram illustrating a system configuration according to a first embodiment of the present invention,

FIG. 2 is an example of a block diagram illustrating a hardware configuration according to the first embodiment of the present invention,

FIG. 3 is a diagram illustrating an example of data history management information according to the first embodiment of the present invention,

FIG. 4 is a flowchart illustrating an example of a process of collecting the data history management information according to the first embodiment of the present invention,

FIG. 5 is a flowchart illustrating an example of a process of mapping of a DB or a file and a volume according to the first embodiment of the present invention,

FIG. 6 is a flowchart illustrating an example of a data recovery process according to the first embodiment of the present invention,

FIG. 7 is a flowchart illustrating an example of security threat detection and a data management process according to a second embodiment of the present invention, and

FIG. 8 is a diagram illustrating an example of data similarity information according to a third embodiment of the present invention.

### DETAILED DESCRIPTION

Data recovery using the latest data as possible is implemented by using data lineage indicating a history of a copy of data and transformed data during the use of the data.

In recovery from copy data, a relationship between a source and a destination of data copy that occurs during use of data is held as lineage.

Thus, even when original data or backup data is infected with ransomware, it is possible to search for copy data using the data linage and recover the data using the found data.

In a case where copy data during use of data is used as a cache, when it is detected that original data or backup data is infected with ransomware, the copy data is stored to a nonvolatile memory, instead of being stored to the cache. When the data is recovered from the infection, the data is returned to the cache.

When infection can be detected during a data formatting process, data is recovered from data of a previous generation. When copy data is infected, an error occurs in a formatting process or an analysis process, it is possible to detect infection with ransomware. In a case where copy data of a previous generation is stored and data cannot be analyzed using the latest copy, processing can be performed with the copy data of the previous generation.

In data processing, a tag is inserted in data in order to easily analyze the data after the processing, a process of formatting data and a process of interpolating the data are performed. The data after these processes is almost the same data as the original data.

In a case where data cannot be recovered using backup data or cache data, it is possible to determine whether the data can be used, based on a similarity between the data after the processing and the analysis process and the original data. In this case, a system queries a data administrator or an infrastructure administrator about recovery using the formatted data, receives information indicating approval of the data administrator or the infrastructure administrator, and recovers the data.

Embodiments of the present invention will be described with reference to the drawings.

### First Embodiment

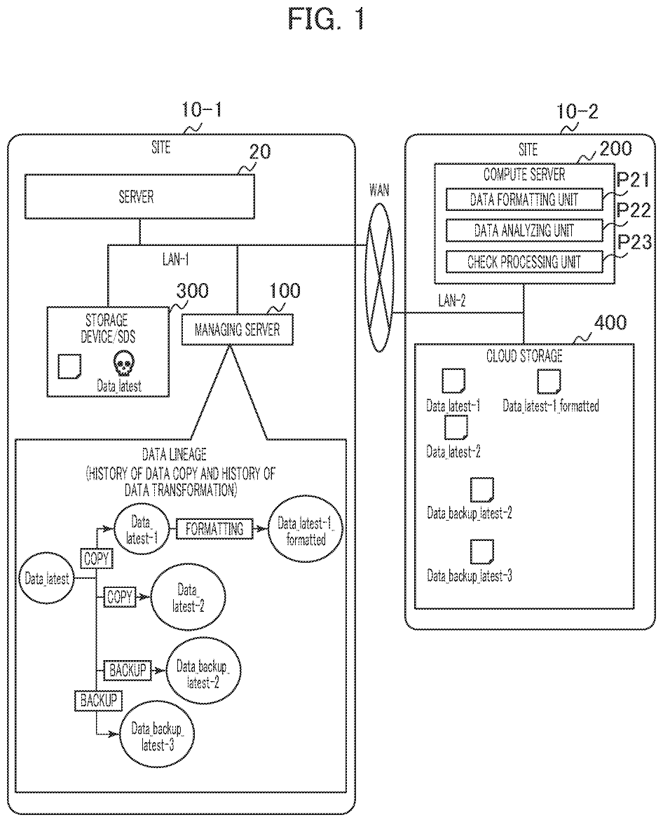

FIG. 1 is an example of a block diagram illustrating a system configuration according to a first embodiment of the present invention.

In a site 10-1, a storage device 300 is connected to a managing server 100 and a server 20 via a LAN-1.

The server 20 writes data to the storage device 300. In the storage device 300, original data is stored and periodically backed up. The backup data is backed up to a cloud storage 400 in a site 10-2 via a WAN.

Data_backup_latest-2 and Data_backup_latest-3 stored in the cloud storage 400 are backup data that is two or three backup generations older than the latest data Data_latest in the storage device 300.

A compute server 200 in the site 10-2 performs data analysis using a data formatting unit P21 and a data analyzing unit P22.

Therefore, a snapshot of the latest data is acquired in the storage device 300, Data_latest-1 and Data_latest-2 that are data of the snapshot is stored to the cloud storage 400 via the WAN. Data_latest-1 and Data_latest-2 are snapshot data that is one or two older than the latest data Data_latest. The snapshot acquired in the storage device 300 is transferred to the cloud storage 400 and deleted.

The data formatting unit P21 that operates on the compute server 200 performs, for example, a process of formatting data using Data_latest-1 stored in the cloud storage 400, generates Data_latest-1 formatted, and stores the generated Data_latest-1 formatted to the cloud storage 400.

The data analyzing unit P22 performs an analysis process including machine learning and deep learning using the formatted Data_latest-1 formatted.

A check processing unit P23 performs a check process of checking that selected data is not infected with a virus such as ransomware when data is to be restored based on data lineage.

The managing server 100 manages the storage device 300 and generates data lineage (data history) by collecting a history of a data copy and a history of data transformation.

When the latest data Data_latest stored in the storage device 300 is exposed to a security threat such as ransomware for example, the data lineage managed by the managing server 100 is referred to and data is recovered using the latest data as possible in the present invention.

For example, an update time of the latest backup data Data_backup_latest-2 is compared with an update time of Data_latest-1 copied for data processing, data is recovered using the latest data as possible.

This minimizes loss of business opportunities.

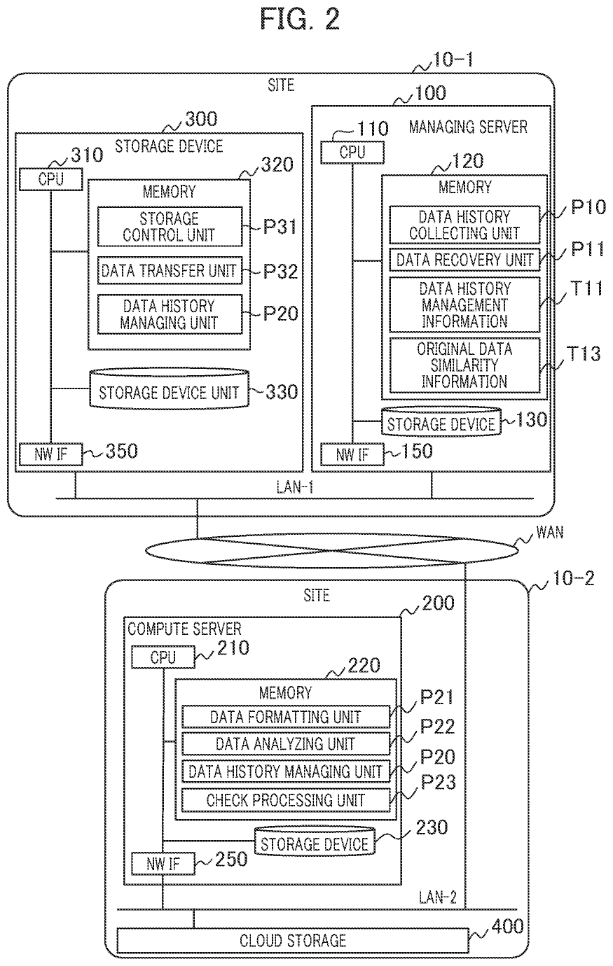

FIG. 2 is an example of a block diagram illustrating a hardware configuration according to the first embodiment of the present invention.

The site 10-1 and the site 10-2 are connected to each other via the WAN. Each of the site 10-1 and the site 10-2 may be an on-premise private cloud or a public cloud.

In the present embodiment, the site 10-1 is an on-premise private cloud and the site 10-2 is a public cloud.

In the site 10-1, the storage device 300 and the managing server 100 are connected to each other via the LAN LAN-1. The managing server 100 may be included in the storage device 300. In the present embodiment, the managing server 100 is an independent physical device. The storage device 300 may be a storage cluster formed by one or more devices.

The storage device 300 includes a CPU 310, a memory 320, a storage device unit 330, a network interface (NW IF) 350. The memory 320 includes a storage control unit P31, a data transfer unit P32, and a data history managing unit P20.

The storage control unit P31 stores data transmitted from a host (not illustrated) via I/O to a storage device by using data protection such as RAID or Erasure Coding, and performs storage control such as acquisition of a snapshot, and application of processing such as compression and deduplication.

The data transfer unit P32 backs up data held in the storage device 300, for example, to the cloud storage 400 in the site 10-2, transfers data for data utilization, and returns data held in the cloud storage 400 to the storage device 300.

The data history managing unit P20 acquires and holds information indicating a data transfer source, a data transfer process, a data transfer destination, and a date and time when the transfer process is performed, and a flag indicating whether data is normal, when the data is backed up or copied.

For example, when a backup process is performed, information indicating the storage device 300 is stored as a data transfer source, information indicating backup is stored as data processing, information indicating the cloud storage 400 is stored as a data transfer destination, a time when a data transfer process is performed is stored, and a normal flag is stored as “normal” when the backup process is successfully performed.

In addition, when target data in a data transfer source is present in a volume, the name of the volume or a number of the volume is stored. When the target data is present in a file system, the name of the file system is stored. When the target data is in a directory or a file unit, a path to the directory or the file unit is stored.

The data history managing unit P20 may be included in the data transfer unit P32, the data formatting unit P21, or the data analyzing unit P22.

The managing server 100 includes a CPU 110, a memory 120, a storage device 130, an NW IF 150.

In the memory 120, a data history collecting unit P10, data history management information T11, and original data similarity information T13 for each data process are held.

The data history collecting unit P10 acquires data copy held in the data history managing unit P20 of the storage device 300, data copy held in the data history managing unit P20 of the compute server 200, and history information of data transformation and data processing, and stores the acquired data copy and the acquired history information to the data history management information T11 described later. The original data similarity information T13 for each data process will be described in a third embodiment.

The data recovery unit P11 refers to the data history management information T11 and the like, requests available data, and recovers data when an error occurs in the compute server due to infection of a DB or a file with a virus.

In the site 10-2, the compute server 200 and the cloud storage 400 are connected to each other via a LAN-2.

The compute server 200 includes a CPU 210, a memory 220, a storage device 230, and an NW IF 250. In the memory 220, a data formatting unit P21, a data analyzing unit P22, and a data history managing unit P20 are developed.

The data formatting unit P21 performs a process of formatting and processing data stored in the cloud storage 400 such that the data analyzing unit P22 easily processes the data. The formatted and processed data is stored as other data in the cloud data 400.

The data analyzing unit P22 performs an analysis process including deep learning and machine learning on the formatted and processed data. The data generated by the analysis process is stored as other data in the cloud storage 400.

The data formatting unit P21 and the data analyzing unit P22 may be managed services provided by a cloud.

The data history managing unit P20 acquires and stores data before data processing, the content of the processing, data after the processing, a date and time when the data is processed, and a flag indicating whether the data is normal, when the data formatting unit P21 performs a process of transforming or processing the data or the data analyzing unit P22 performs the analysis process such as deep learning or machine learning.

For example, when the process of processing the data is performed, the data Data_latest-1 stored in the cloud storage 400 is stored as the data before the data processing, information indicating the process of formatting the data is stored as the content of the processing, Data_latest-1 formatted is stored as the data after the processing, Data_latest-1 formatted data storage time is stored as the date and time when the data is processed, and a normal flag is stored as normal when the process of processing the data is successfully performed without an error.

The cloud storage 400 is a storage service built on the cloud.

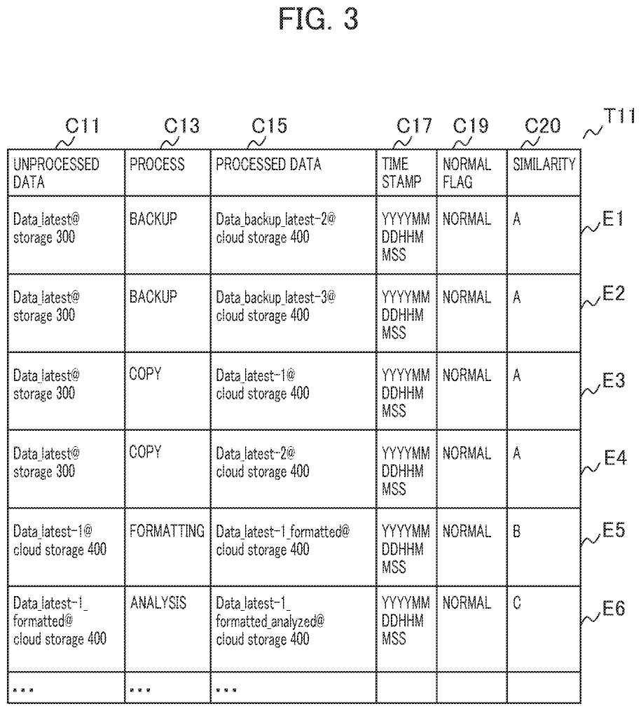

FIG. 3 is a diagram illustrating an example of the data history management information T11.

The data history management information T11 includes unprocessed data C11, a process C13, processed data C15, a timestamp C17, a normal flag C19 indicating normal in case that an error does not occur when the process C13 is performed, and a similarity C20 indicating how similar the processed data is to the original data.

In this example, the similarity is classified into three levels, A, B, and C. A indicates that the processed data is almost the same as the original data. B indicates that the processed data is almost the same as the original data although tag data, complementary data, or the like is added to the processed data. C indicates that the processed data is different from the original data and used for analysis in machine learning.

The similarity may not be classified into the three levels. A degree of match between the processed data and the original data may be stored. Since the processed data C15 and the similarity C20 are stored in association with each other, it is possible to recover the data using data of which a degree of match is high based on the similarity.

In addition, when the similarity is determined based on the content of the process C13, the priority of the processed data to be used to recover the data may be determined based on the content of the process. For example, priorities may be determined such that processed data that is subjected to copying, formatting, and analysis that are processes in which a similarity is likely to be high.

An example of the data transfer unit is described below. As indicated by an entry E1, in the storage device 300, when the data transfer unit P32 daily acquires a backup, Data_latest@storage 300 is stored as the unprocessed data C11, backup is stored as the process C13, Data_backup_latest-2@cloud storage 400 is stored as the processed data C15, a date and time when the process is performed and data is stored are stored as the timestamp C17, and normal is stored as the normal flag C19. Since the stored data is backup data, A indicating the highest similarity is stored as the similarity C20.

In this case, it is necessary that “Data_latest” as the unprocessed data C11 and “Data_backup_latest-2” as the processed data be names that can be identified by a user, such as DB names or file names.

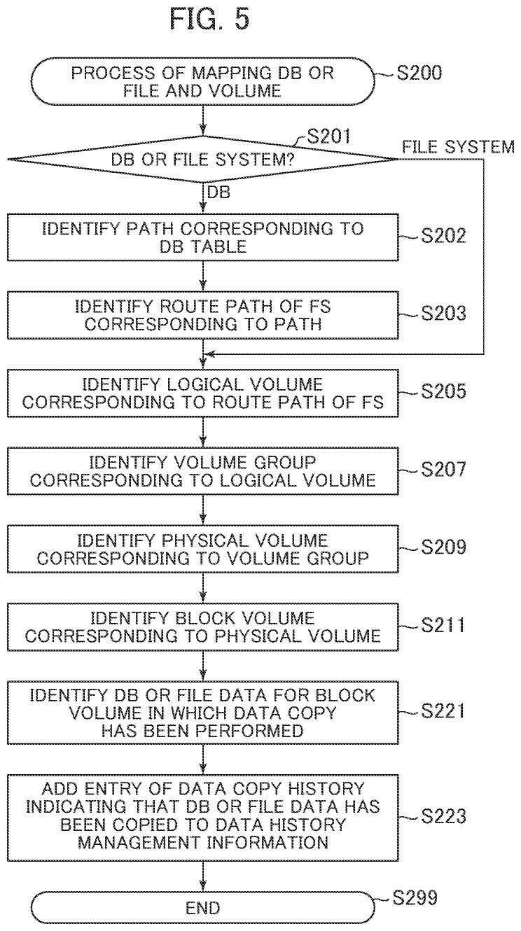

Therefore, to use a result of copying or backing up data in units of volumes in the storage device, it is necessary to perform a mapping process illustrated in FIG. 5.

Data_backup_latest-3@cloud storage 400 as the processed data C15 indicated in an entry E2 indicates backup performed one day before the above-described backup.

Next, an example of the data transfer unit is described using entries E3 to E5. The data formatting unit P21 and the data analyzing unit P22 on the compute server 200 perform processes of formatting and analyzing data on the storage device 300.

First, the storage device 300 performs a process of copying the data by the data transfer unit P32.

In this case, as indicated by the entry E3, Data_latest@storage 300 is stored as the unprocessed data C11, copy is stored as the process C13, Data_latest-1@cloud storage 400 is stored as the processed data C15, a date and time when the process is performed and the data is stored are stored as the timestamp C17, and normal is stored as the normal flag C19.

The entry E4 indicates the data copied for data analysis before the entry E3.

Next, the process of formatting the data is performed using the copied data. As indicated by the entry E5, Data_latest-1@cloud storage 400 is stored as the unprocessed data C11, formatting is stored as the process C13, Data_latest-1 formatted@cloud storage 400 is stored as the processed data C15, a date and time when the process is performed and the data is stored are stored as the timestamp C17, and normal is stored as the normal flag C19.

Lastly, the analysis process is performed using the formatted data. As indicated by the entry E6, Data_latest-1 formatted@cloud storage 400 is stored as the unprocessed data C11, analysis is stored as the process C13, Data_latest-1 formatted analyzed@cloud storage 400 is stored as the processed data C15, a date and time when the process is performed and the data is stored are stored as the timestamp C17, and normal is stored as the normal flag C19.

As described above, a history of a data copy process and a history of data processing and analysis can be managed using the same format. In the present embodiment, these histories are referred to as data history management information.

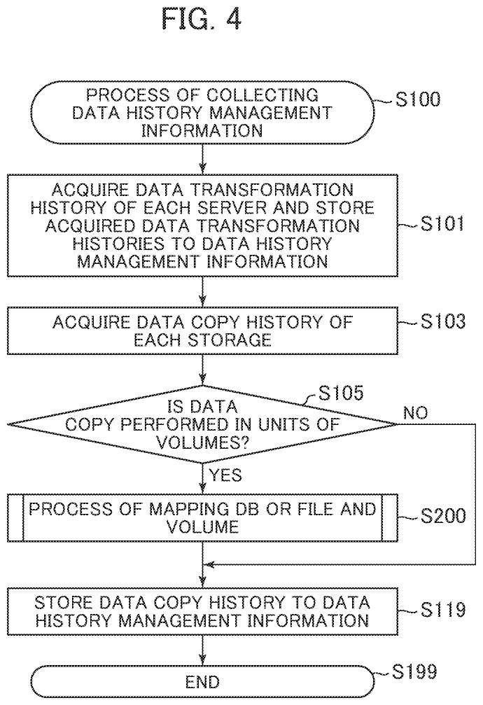

FIG. 4 is a flowchart of a process of collecting the data history management information in a state in which data copy, data processing and analysis process are performed for data backup and data utilization.

S101: The data history collecting unit P10 on the managing server 100 requests the data history managing unit P20 on each server that performs data processing and an analysis process to provide histories of the data processing and the analysis process, and the data history managing unit P20 of each server provides the histories to the data history collecting unit P10.

The data history collecting unit P10 acquires the histories relating to the data processing and analysis performed in each server, and stores the acquired histories to the data history management information T11.

S103: The data history collecting unit P10 on the managing server 100 requests the data history managing unit P20 on each storage in which a data copy process is performed to provide histories of the data copy process, and the data history managing unit P20 on each server provides the histories to the data history collecting unit P10.

S105: When the data copy is performed in units of volumes in the storage, the data used in the data processing and stored in a DB is file data, it is necessary to perform mapping of the data and a volume in which the data is copied or backed up.

Therefore, the data history collecting unit P10 determines whether the data copy is performed in units of volumes. When the data copy is performed in units of volumes, the data history collecting unit P10 performs S200. When the data copy is not performed in units of volumes, the data history collecting unit P10 performs S119.

S119: The data history collecting unit P10 stores a history of the data copy to the data history management information T11.

S199: The data history collecting unit 10 completes the process of collecting the data history management information.

S101 in which the histories relating to the data processing and the analysis process in each server are acquired, and S103 to S119 in which the histories of the data copy in the storage are acquired may be performed in reverse order or may be performed in parallel.

FIG. 5 illustrates the process S200 of performing mapping of a DB or file data and a block volume when the data history collecting unit P10 operating on the managing server 100 checks histories of the data copy process and the backup process performed by the data transfer unit P32 of the storage device 300, and the data copy process and the backup process are performed in units of block volumes.

S201: The data history collecting unit P10 on the managing server 100 determines whether the compute server uses a volume provided by the storage device 300 as a DB or as a file system.

It is assumed that the right of access to the DB and the right of access to the file system are registered in the managing server by an administrator in advance. When the compute server uses the volume as the DB, the data history collecting unit P10 performs S202. When the compute server uses the volume as the file system, the data history collecting unit P10 performs S205.

S202: When the compute server uses the volume as the DB, the data history collecting unit P10 acquires a path on a file system in which a DB table is stored.

In the acquisition of the path, the path may be identified from a file name or a directory name on the file system based on an API provided by the DB or the name of the DB table.

S203: a route path of the file system is identified from the above-described path.

S205: A logical volume is identified from the route path of the file system. The logical volume can be identified by executing a command provided by an OS or referring to a setting file for associating the file system with the logical volume.

S207: A volume group corresponding to the logical volume is identified. The identification of the volume group is checked by executing a command provided by the OS.

S209: A physical volume corresponding to the volume group is identified. The identification of the volume group is checked by executing a command provided by the OS.

S211: The identification of the block volume provided by storage corresponding to the physical volume is checked by executing a command provided by the OS or by the storage device.

By performing the above-described process, it is possible to perform the mapping of the DB or the file data used by the compute server with the block volume.

S221: The DB or the file data for the block volume in which the backup is actually performed is identified from the above-described mapping.

S223: An entry of a data copy history is added to the data history management information T11 as a history of data copy or backup of the identified DB or of the identified file data.

S299: The process is completed.

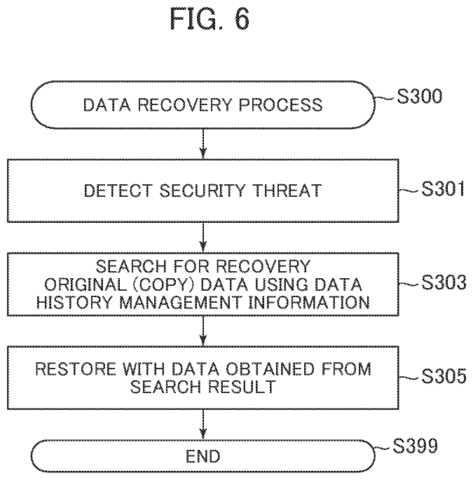

FIG. 6 is a flowchart illustrating a process of the data recovery unit P11 that indicates the data recovery process S300 when data stored in the storage device 300 is exposed to a security threat such as ransomware.

S301: The storage device 300 detects the security threat.

The security threat may be detected by a tool operating in the storage device or a tool operating in the compute side that uses the storage device.

S303: The data recovery unit P11 of the managing server 100 refers to the data history management information T11 and identifies the latest copy of data suspected of being infected.

The data recovery unit P11 refers to the unprocessed data C11 of the data history management information T11, identifies an entry of data that needs to be recovered, and searches for and identifies the latest copy data relating to the data by referring to the process C13 and the timestamp C17 and checking the normal flag C19 indicating normal.

Based on the process C13, it can be found that the process is a process of copying the data. In addition, based on the timestamp, it is possible to determine a point of time when a copy of the data is generated.

S305: The data recovery unit P11 checks with the administrator whether the data is to be restored using the data found from a result of the search, and restores the data when the restoration is approved by the administrator.

In the first embodiment, it is possible to recover data exposed to a security threat from the latest copy data as possible by using a history of data_backup or data copy for data utilization.

A second embodiment describes an example in which infection with a security threat when data is formatted during the use of data is detected and data is recovered from data of a previous generation.

For example, when a security threat such as ransomware occurs, and data is copied for backup or data processing, there is a possibility that the copy data may be already infected.

In this case, it is necessary to detect the security threat and recover the data as early as possible.

In the second embodiment, when copy data is infected during data processing, formatting and analysis processes fail and an error occurs. Based on the failure, a security threat is detected.

In addition, when copy data of a previous generation is stored in data processing, and data cannot be analyzed with the latest copy, the data is recovered using the copy data of the previous generation.

The same processing as that described in the first embodiment will not be described. Security threat detection and a data management process during data processing will be described, which are different from the first embodiment.

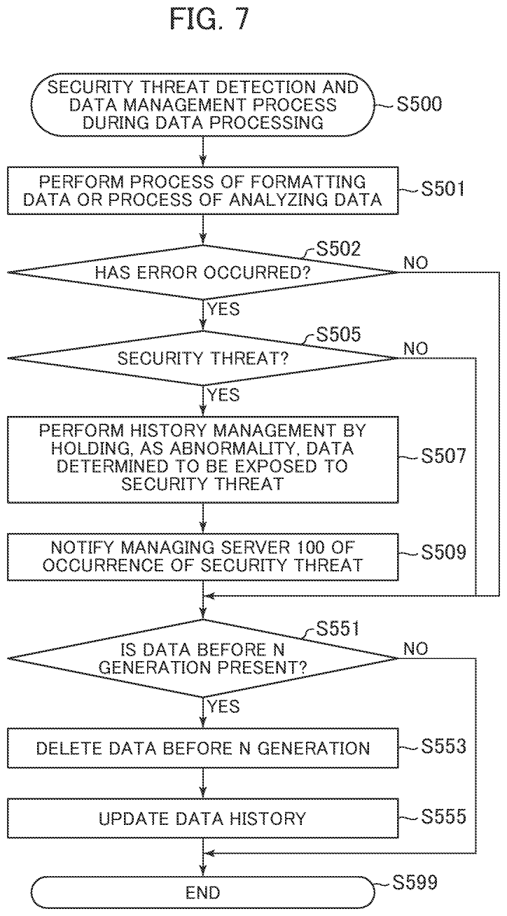

FIG. 7 is a flowchart illustrating an example of the security threat detection and the data management process in the second embodiment of the present invention.

S501: A data formatting unit P21 or a data analyzing unit P22 on a compute server 200 performs a process of formatting data or a process of analyzing data.

S502: The data formatting unit P21 or the data analyzing unit P22 performs S551 when an error does not occur. When an error occurs, the data formatting unit P21 or the data analyzing unit P22 performs S505.

S505: the data formatting unit P21 or the data analyzing unit P22 determines the error caused by the security threat.

For example, in a case where data cannot be read due to the encoding or the like in the first place, the data formatting unit P21 or the data analyzing unit P22 determines the security threat. When the data formatting unit P21 or the data analyzing unit P22 determines the security threat, the data formatting unit P21 or the data analyzing unit P22 performs S507. When the data formatting unit P21 or the data analyzing unit P22 does not determine the security threat, the data formatting unit P21 or the data analyzing unit P22 performs S551.

S507: A data history managing unit P20 holds, as an abnormality, data determined to be exposed to the security threat.

S509: The data history managing unit P20 notifies a managing server 100 of the occurrence of the security threat. The managing server 100 collects data histories in S100 and performs the data recovery process S300.

S551: The data history managing unit P20 determines whether data before an N generation is present in cloud storage 400 for copy data for data processing. N may be a value specified in a setting file or the like. When the data before the N generation is present, the data history managing unit P20 performs S553. When the data before the N generation is not present, the data history managing unit P20 performs S599 and completes the process.

S553: The data history managing unit P20 deletes the data before the N generation.

S555: A data history is updated to reflect the deleted data.

In the second embodiment, when a security threat such as ransomware occurs, and data is copied for backup or data processing, there is a possibility that a copy of the data may be already infected.

When copy data is infected during the data processing, the formatting and analysis processes fail and the security threat is detected based on the analysis of the failure.

When copy data of a previous generation is stored on the data processing side, and data cannot be analyzed using the latest copy, management is performed such that the data is recovered using the copy data of the previous generation.

Therefore, it is possible to early detect the security threat and recover the data using the latest data as possible.

A third embodiment describes an example in which data is recovered from data after data formatting against a security threat during data processing.

In data processing, a tag is inserted in data, the data is formatted and interpolated in order to easily analyze the data after the data processing.

The data after this processing is almost the same as the original data. When data cannot be recovered in the first and second embodiments, a system proposes the recovery with the formatted data to a data administrator and an infrastructure administrator, obtains approval of the data administrator and the infrastructure administrator, and recovers the data.

The third embodiment describes only original data similarity information T13 for each data process used in the data recovery process S300 and a changed part of the data recovery process S300 that uses the original data similarity information T13, which are different from the first embodiment.

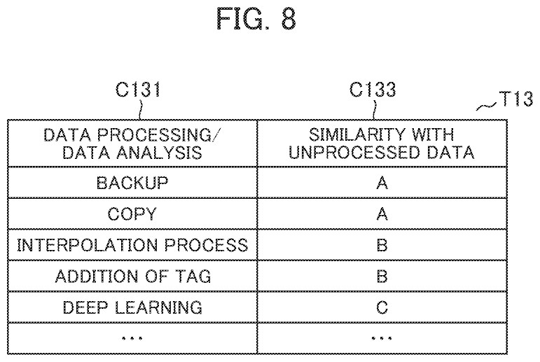

FIG. 8 is a diagram illustrating an example of the data similarity information according to the third embodiment of the present invention. The data similarity information includes data processing C131 and a similarity C133 with data before the processing.

The data processing C131 indicates a process of processing and analyzing data. The similarity C133 with data before the processing indicates a similarity between the data obtained by the data processing C131 and the original data. The similarity may be obtained using a tool that determines the similarity, or administrators that include a data analyzing person may set the similarity.

For example, since backup data and copy data are the same as the original data, similarities C133 are set to A. Since a change from the original data is small in data interpolation processing and formatting processing for addition of a tag, similarities C133 are set to B that indicates a high similarity.

On the other hand, data generated in an analysis process such as deep learning does not have a similarity with the original data, and thus a similarity C133 is set to C.

The similarity does not need to be classified into the three levels and may be used as an index indicating a degree of match with the original data.

A similarity with the original data for each data process can be managed using the original data similarity information T13.

A data recovery method using the original similarity information T13 is described. In a search of recovery original (copy) data using the data history management information in the data recovery process S300, when normal copy data is not found, the original data similarity information T13 is referred to and data having a high similarity is identified. Thereafter, S305 is performed.

In the third embodiment, when a security threat such as ransomware occurs, and it is difficult to recover data using normal copy data, a means for recovering the data using data having a high similarity with the original data by data processing and an analysis process during data processing is provided. Therefore, it is possible to recover the data using the latest data as possible.

What is claimed is:

1. A data recovery method for recovering data stored in a storage system,
the data recovery method comprising:
causing a storage device to hold original data;
causing an analyzing server including a data analyzing unit to hold copy data that is a copy of the original data, and generate formatted data obtained by formatting the copy data for analysis;
causing a managing server to hold the copy data and data history management information storing a history of the formatted data; and
causing a data recovery unit to refer to the data history management information, select the copy data or the formatted data as recovery data, and recover the data from the selected recovery data when a security threat is detected in the data.

2. The data recovery method according to claim 1, wherein it is determined that the security threat is detected when an error occurs in a process of formatting the data or a process of analyzing the data.

3. The data recovery method according to claim 1, wherein
the data history management information includes flag information indicating that data processed without an error is normal, and
the data recovery unit uses, as the recovery data, data for which the flag information indicates normal.

4. The data recovery method according to claim 2, wherein
the storage device performs a backup process of backing up data to other storage,
the data history management information includes time information indicating a time when the data is processed, and
the data recovery unit selects data as the recovery data based on time information indicating a time when a copy process and the backup process are performed.

5. The data recovery method according to claim 1, wherein
process types of the data history management information include types of copy, formatting, and analysis, and
the data recovery unit selects data as the recovery data in order of copying, formatting, and analysis.

6. The data recovery method according to claim 5, wherein
the data history management information includes similarity information indicating a difference from the unprocessed data,
when a process type of the data history management information is formatting or analysis, an output unit outputs a similarity of the selected data, and
when an input unit receives information indicating approval of use of the selected recovery data, the data recovery unit uses the selected data as the recovery data.

7. A data recovery system that recovers data stored in a storage system, the data recovery system comprising:
a storage device that holds original data;
an analyzing server that holds copy data that is a copy of the original data, and generates formatted data obtained by formatting the copy data for analysis;
a managing server that holds the copy data and data history management information storing a history of the formatted data; and
a data recovery unit that refers to the data history
management information, selects the copy data or the formatted data as recovery data, and recovers the data from the selected recovery data when a security threat is detected in the data.
